(19) United States
(12) Patent Application Publication
(10) Pub. No.: US 2005/0052663 A1
(43) Pub. Date: Mar. 10, 2005

(54) Image source-file DPI printing-scale control

(75) Inventors: Jiaping Song, Vancouver, WA (US); John J. Burlingame, Camas, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/726,369

(22) Filed: Dec. 2, 2003

Related U.S. Application Data
(60) Provisional application No. 60/500,459, filed on Sep. 5, 2003.

(51) Int. Cl. G06F 15/00

(52) U.S. Cl. 358/1.2

(57) ABSTRACT

A system and method for printing scale control utilizing, for control purposes, a validated image-source-file data flag which contains information describing the actual original image size in terms of dots-per-inch and total number of bits.

### CROSS REFERENCE TO RELATED APPLICATION

This application claims priority to U.S. Provisional Patent Application Ser. No. 60/500,459 covering an invention entitled “Image Source-File DPI Printing-Scale Control”, filed Sep. 5, 2003. The inventorship is the same in that provisional case as in this application, and the entirety of that provisional patent application is hereby incorporated herein by reference.

### BACKGROUND AND SUMMARY OF THE INVENTION

This invention pertains to control over digital image printing-size accuracy relative to the original size of a source image, where printing is specially implemented from an image data file that has been generated from the source image. More particularly it relates to the creation and/or use of such a data file which contains validated information that accurately, effectively describes actual source-image size. The general terms “source file” and “source image”, as variously used herein in text, are intended to refer to the actual original image-area size of a document, for example, which is intended to be captured, and later faithfully printed with essentially exactly the same size.

Selected original images which are chosen to be captured, as by scanning, for the purpose of becoming recorded in related digital image data files to enable later printing are typically “recorded” in such a file with added border/marginal regions that are definitively not a part of the original subject images. When such a file-captured image is then printed, conventional printing modalities, that normally “intend” to print a “same-size” image, don't do so for the reason that they typically include, in the intended, same-size printed image, the superfluous border region. The obvious and distracting consequence of this behavior is that the true original “selected image” is actually printed at less than full original size. Such distortion, of course, telegraphs its presence proportionally and directionally into any other-than one-to-one scaled printing operation.

The present invention addresses and eliminates this size-mismatch problem. It does so by creating and/or using, for subsequent, positive, image-printing control, an image data file which is structured to contain clearly readable, useable, and validated-as-being-correct, information regarding actual original image size.

These and the other features and advantages which are offered by the present invention will become more clearly apparent as the description which now follows is read in conjunction with the accompanying drawings.

### DESCRIPTION OF THE DRAWINGS

FIG. 1 is a stylized and schematic view illustrating prior art print-sizing problems which are addressed and resolved by implementation and practice of the present invention.

FIG. 2 is a block/schematic diagram illustrating the structure and methodology of the present invention.

FIG. 3 is a fragmentary view illustrating a modified portion of the system and methodology pictured in FIG. 2, specifically illustrating an approach to practicing the invention which includes specifically the step, and structure for implementing the step, of introducing a validated size-control flag in an image source data file in accordance with practice of the invention.

### DETAILED DESCRIPTION OF THE INVENTION

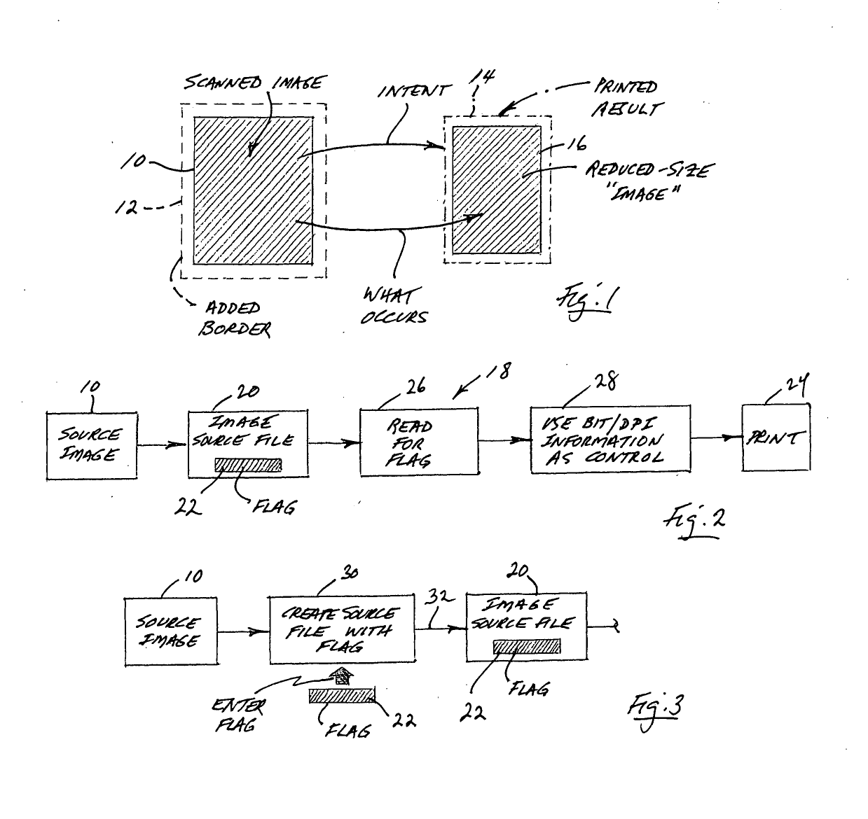

Turning attention now to the drawings, and referring first of all to FIG. 1, what is illustrated herein in a stylized and graphically somewhat exaggerated way is the print-sizing prior art problem mentioned earlier herein, which problem is specifically addressed and definitively resolved by implementation and practice of the present invention. Shown generally at 10 in FIG. 1 is a shaded block representing an original scanned image which forms the source image for a later intended printing of this image. According to conventional practice, when such an image is prepared, as by scanning, to create a related digital data file that can be sent ultimately to a printer for printing, and where, as is very often the case, this preparation is performed by a scanning function, it is typical in prior art behavior that effectively a clear border, represented in dashed lines at 12, is added as a virtual surround regarding the original image. This border creates a real data file which possesses what will later appear to be an image which is actually larger than the intended, scanned, original image.

It is, usually, intended that the printed result from this activity, as indicated by the slightly curved arrow marked “Intent” in FIG. 1, will be printed in the correct original size of image 10, and this intended printed result is shown at 14 in dash-dot lies in FIG. 1. However, because of the presence of added border 12, and in accordance with conventional prior-art system behavior, what really occurs is that the entirety of the data file which includes original image 10 and border 12 is sized to fit the region marked 14 in FIG. 1, with the consequence that the actual original scanned image, shown by a shaded block 16 on the right side in FIG. 1, ends up proportionately reduced in size.

It is this undesirable and unfaithful size reproduction of the original image to which the present invention directs its attention.

A preferred embodiment and manner of practicing the invention are illustrated generally at 18 in FIG. 2. Here, in FIG. 2, the original source image, i.e. that intended image which is scanned and which is desired to be printed, for example, in full original size, is shown by block 10.

According to the invention, during or after scanning of source image 10, the image data file is armed with what is referred to herein as a flag which places in the file validated data which describes, effectively, and accurately, the original image size. While this may be done in, perhaps, a number of different specific manners, in accordance with a preferred manner of practicing the invention, this flag carries information that effectively describes the actual number of dots-per-inch (DPI) in the scanned image source file, along with additional information, such as the actual number of bits or dots contained in the scanned image, and a further indication that these pieces of information are correct and accurate. Such an image source file is shown at 20 in FIG. 2 containing such a flag which is shown at 22 by a shaded block in FIG. 2.

Continuing with a description now of practice of the invention, with this specially constructed image source file now en route to ultimate printing by a printer, such as that represented by block 24 in FIG. 2, and in accordance still with practice of the present invention, the image source file is read by a block shown at 26 which looks for the presence of a flag, such as flag 22. Block 26 is also referred to herein both as examining structure and as a detecting structure. When it locates such a flag, it uses the validated information contained in the flag, in accordance with practice indicated by block 28 in FIG. 2, to employ directly the flag data to control actual printing size, whereby the resulting printed image will end up in accordance with the intended image shown by dash-dot lines 14 in FIG. 1. Block 28 constitutes both a flag using structure and a utilizing structure herein.

FIG. 3 in the drawings illustrates a modified manner of practicing the invention. Whereas in FIG. 2, practice of the invention can be performed in a setting where, in any suitable fashion, a flagged image source file is created with accurate “original image size” information, in the FIG. 3 modified form of the invention, practice thereof consciously implements the step of introducing a flag into the construction of a source file, such as a source file derived from scanned-image data. Block 30 in FIG. 3, labeled “Create Source File with Flag”, represents this modified form of the invention, and it is within the practice that is performed as represented by this block that flag 22 is introduced and entered at the time of creating image source file 20. Block 30 is also referred to herein as an associating structure, and the operative connection shown as an arrow-headed line 32 in FIG. 3 extending between blocks 30, 20 is referred to herein as sending structure.

The invention is thus described now in its preferred and best mode embodiment and manner of practice. Additionally, it is described in relation to one modified form of implementing and practicing the invention. Accordingly, while we have described this invention in preferred and best mode manners, and have further described a modified implementation and practice of the invention, we appreciate that variations and modifications may be made without departing from the spirit of the invention.

1. A method for providing printing scale control with respect to a digital source image which is associated with a related, validated, data-content flag that describes the actual size of the image in terms of dots-per-inch, and number of bits, comprising
examining such a source image to detect the presence of such a flag, and
on detecting such a flag, using the information contained in it to control printed image size.

2. A method for providing printing scale control with respect to a digital image described by a data file having a known dots-per-inch characteristic, and a known total number of bits, comprising
associating with the image data file a validated data-content flag which describes the image in terms of its dots-per-inch characteristic and its total number of bits,
sending this image data file along with the associated data-content flag en route to a printer,
within that route, and upstream from the printer, detecting the presence of the flag, and
utilizing the information contained in the flag to control printed image size.

3. Apparatus for providing printing scale control with respect to a digital source image which is associated with a related, validated, data-content flag that describes the actual size of the image in terms of dots-per-inch, and number of bits, comprising
examining structure for examining such a source image to detect the presence of such a flag, and
flag using structure operatively connected to said examining structure and operable, on the examining structure detecting the presence of such a flag, to use the information contained in that flag to control printed image size.

4. Apparatus for providing printing scale control with respect to a digital image which is described by a data file having a known dots-per-inch characteristic, and known total number of bits, said apparatus comprising
associating structure for associating with such an image data file a validated data-content flag which describes the image in terms of its dot-per-inch characteristic and its total number of bits,
sending structure operatively associated with said associating structure operable, following the performance of said associating structure, to send the image data file along with the associated data-content flag en route to a printer,
operatively disposed within that route, and upstream from the printer, detecting apparatus for detecting the presence of the associated flag, and
utilizing structure operatively connected to said detecting structure for utilizing the information contained in the flag to control printed image size.
